(19) United States
(12) Patent Application Publication
(10) Pub. No.: US 2019/0107280 A1
(43) Pub. Date: Apr. 11, 2019

(54) ELECTRICAL POWER GENERATION SYSTEM

(71) Applicant: SIGMA ENERGY STORAGE INC., Dorval (CA)

(72) Inventor: Richard BOUDREAULT, St-Laurent (CA)

(21) Appl. No.: 16/089,245

(22) PCT Filed: Apr. 3, 2017
(86) PCT No.: PCT/CA2017/050408

§ 371 Date: Sep. 27, 2018

Related U.S. Application Data
(60) Provisional application No. 62/316,825, filed on Apr. 1, 2016.
(60) Provisional application No. 62/394,980, filed on Sep. 15, 2016.

(51) Int. Cl. F23J 15/02; F23J 15/00; B01D 45/12; B01D 53/26; C01B 32/50

(52) U.S. Cl. CPC F23J 15/027; F23J 15/02; F23J 15/006; F23J 2900/15061; B01D 53/265; C01B 32/50; F23J 2215/50; B01D 45/12

(57) ABSTRACT

An electrical power generation system. It has a combustion energy prime mover having a combustion gas exhaust; an electrical generator connected to the prime mover connectable to a local power grid; a gas compressor receiving the combustion gas exhaust and providing pressurized gas and gas compression heat; and a liquid carbon dioxide collector for collecting liquid carbon dioxide from the pressurized gas.

The present patent application claims priority from US provisional application U.S. 62/316,825 filed on Apr. 1, 2016, and US provisional application U.S. 62/394,980 filed on Sep. 15, 2016.

### TECHNICAL FIELD

The present application relates to combustion electrical power generation and to thermal and compressed air energy storage systems.

### BACKGROUND

Carbon dioxide (CO2) is the primary greenhouse gas emitted through human activities. In 2012, CO2 accounted for about 82% of all U.S. greenhouse gas emissions resulting from human activities.

The remediation of carbon dioxide emitted into the atmosphere has become a serious issue due to the important contribution of CO2, as a Greenhouse Gas (GHG), to global warming. Carbon dioxide is naturally present in the atmosphere as part of the Earth's carbon cycle. However, human activities are altering the carbon cycle both by adding more CO2, through organic and inorganic combustion mechanisms, to the atmosphere and by influencing the ability of natural sinks, like forests and oceans, to remove CO2 from the atmosphere. While CO2 emissions come from a variety of natural sources, human related emissions are responsible for the increase that has occurred in the atmosphere since the industrial revolution. Global climate change concerns may necessitate capture of CO2, e.g., from flue gases and other process streams. One traditional approach involves absorption of CO2 with an amine solution, such as monoethanolamine (MEA) or ethanolamines. On the other hand, Other processes use catalytic or electrocatalytic reactions to absorb the emitted carbon dioxide, or use geological mineralization using geological systems. These processes are quite expensive and complicate the handling of large masses of flue gases. In some cases, even if a large mass of flue gases can be handled, the kinetics tied to the capturing process are too slow rendering the capture of greenhouse gases difficult when handling very large flow scales.

Furthermore, electrical diesel generators are relatively inefficient at producing power and can be damaging to the environment, namely due to the combustion gases, such as carbon dioxide, produced by the generators while functioning. The exhaust produced by these diesel-run generators may have a composition ranging anywhere between 12-15% of carbon dioxide. The exhaust also includes NO_{X} and CO.

Moreover, in northern territories, such as Canada's Northwestern Territories, Nunavut and Yukon, or in Alaska, electric generators running on diesel are common for providing electricity to local populations. However, the exhaust produced by these generators also contain significant quantities of small particulates, such as soot. These particulates, inhaled over a prolonged period by humans, may lead to chronic breathing disorders and serious illness. The particulates are also deposited on the snow, which may release heat when struck with solar radiation, causing snow and ice to melt as a result, and decreasing as a result the snow/ice bed albedo.

Therefore, a system capable of improving the energy efficiency of a combustion system, harnessing potential sources of energy loss, while removing damaging particulates from the gas produced during combustion before they may impact the environment, and recycling and storing the greenhouse gases produced, namely the carbon dioxide would be advantageous.

### SUMMARY

The present application relates to systems and methods for enhanced control, separation, and/or purification of CO2 from one or more sources of a mixture of gases in a continuous or semi-continuous, cyclic sorption-desorption process. The systems and methods represent an efficient means of CO2 capture at high pressure and low temperature. The remaining thermal energy that is captured can also be used to further cool the temperature of the pressurized gas and improve the extraction rate. The high-pressure process makes the capture of the large quantity of CO2 at high masse flow rate easy and less expensive because of the non-use of catalysts such as consumable amine solutions. The separation of the CO2 from other flue gases is automatic because of the difference between the different gas liquefaction pressure and temperature. The carbon dioxide may then be converted into a fuel such as carbon monoxide or ethanol.

For instance, after the separation of the CO2 from the other gases, a plasma torch may be used to convert CO2 to the fuel gas, CO. However other dissociation techniques such as those involving the use of a catalyst or an electro catalyst can also be used.

The transformation of the greenhouse gas CO2 is based on the following main reaction, in which one atom of oxygen is dissociated from CO2 to produce carbon monoxide (2CO2 [symbol] 2CO+O2). Through this reaction, the CO2 originating from a variety of combustion plants and processes, including exhaust/flue gas and synthesis gas, can be transformed to the fuel gas, CO.

Before transforming CO2, this greenhouse gas is first to be captured and compressed to a high pressure. The CO2 recovery apparatus can have a compression component. A compressor integral to a compressed air energy storage system (CAES) may be used. The CAES air inlet uses the engine exhaust gases of the diesel generators or the exhaust resulting from any kind of combustion process.

In another embodiment, instead of converting the carbon dioxide into carbon monoxide, it may be converted into ethanol. The conversion of carbon dioxide to ethanol may be performed using a copper nanoparticle N-doped graphene electrode as described in Yang Song et al. “High-Selectivity Electrochemical Conversion of CO2 to Ethanol using a Copper Nanoparticle/N-Doped Graphene Electrode”, ChemistrySelect 2016, 1, 6055-6061.

Moreover, in some embodiments, when the present system is used in a colder climate, the cold air may be harnessed to lower the temperature of the pressurized gas mixture, the drop in temperature resulting in the liquefying of the carbon dioxide contained in the pressurized gas.

A first broad aspect is an electrical power generation system having a combustion energy prime mover having a combustion gas exhaust, an electrical generator connected to the prime mover connectable to a local power grid, a gas compressor receiving the combustion gas exhaust and providing pressurized gas and gas compression heat and a liquid carbon dioxide collector for collecting liquid carbon dioxide from the pressurized gas.

In some embodiments, the power generation system may also have a heat exchanger sub-system in communication with the gas compression heat for heat storage or district heating. The heat exchanger sub-system may be in communication with a cooling system of the combustion energy prime mover. The system may also have a compressed gas motor-generator subsystem for generating electrical power from the pressurized gas.

In some embodiments, the system may have a compressed gas motor-generator subsystem for generating electrical power from the pressurized gas, wherein the heat exchanger sub-system may have a heat exchanger for heating the pressurized gas before or during expansion. The system may have electrical power switching equipment connected to the local power grid for switching over electrical power between the compressed gas motor-generator subsystem and the electrical generator connected to the prime mover without interruption. The system may have electrical power switching equipment for connecting and disconnecting electrical power from the compressed gas motor-generator subsystem to the local power grid to increase a power supply to the local grid during peak demand. The electrical power switching equipment may be further configured to switch over electrical power between the compressed gas motor-generator subsystem and the electrical generator connected to the prime mover without interruption.

In some embodiments, the compressed gas motor-generator may have a gas motor connected to a shaft of the electrical generator connected to the prime mover. The system may also have a controller configured to sense a load demand of the local power grid and in response thereto to cause the compressed gas motor-generator to generate electrical power for the local power grid. The system may also include a fuel generator configured to receive carbon dioxide from the liquid carbon dioxide collector and to produce a fuel therefrom. The fuel generator may have a plasma reactor for converting carbon dioxide into carbon monoxide.

In some embodiments, the system may have an intermittent electrical power source connected to the fuel generator. The system may also have a storage vessel connected to the liquid carbon dioxide collector for storing the liquid carbon dioxide.

In some embodiments, the liquid carbon dioxide collector may include a cooling system for cooling the pressurized gas to improve collection of the liquid carbon dioxide. The cooling system may include a heat exchanger in communication with ambient air, the ambient air typically being below 0 degrees Celsius. The cooling system may have a heat pump, preferably for cooling the pressurized gas to below −15 degrees Celsius, and more preferably to below −25 degrees Celsius. The gas compressor may be configured to compress gas to a pressure in the range of 18 bar to 50 bar, preferably between 24 bar and 35 bar.

In some embodiments, the system may have one or more compressed gas storage vessels for storing the pressurized gas. The system may have a soot separation centrifuge for removing particulates from the combustion gas exhaust. The system may also have a water condenser for condensing water in the pressurized gas and for separating the condensed water from the pressurized gas. In some embodiments, the heat exchanger sub-system also may have a heat storage unit for storing heat.

In some embodiments, the system may have a compressed air storage unit connected to the liquid carbon dioxide collector receiving the remainder of the pressurized gas once the liquid carbon dioxide has been collected by the carbon dioxide collector.

In some embodiments, the system may also have a sub-combustion prime mover for combusting the fuel produced from the liquefied carbon dioxide; and a sub-electrical generator connected to the sub-prime mover.

A second broad aspect is a method of combusting fuel and storing carbon dioxide produced therefrom when the ambient temperature is at least below −15° C. The method includes the steps of combusting an original fuel to produce electrical power, compressing the combustion gas exhaust to produce pressurized gas and gas compression heat, extracting the gas compression heat from the pressurized gas, and further lowering the temperature of the pressurized gas by allowing the pressurized gas to reach the ambient temperature, wherein the further lowering of the temperature causes at least a portion of the carbon dioxide that is part of the pressurized gas to liquefy and separate from the pressurized gas.

In some embodiments, the methods may further involve producing fuel from the liquid carbon dioxide. The producing of the fuel may use an intermittent renewable energy source. The fuel that is produced may be carbon monoxide, and the producing of carbon monoxide may include evaporating the liquefied carbon dioxide, and transporting the gaseous carbon dioxide into a central channel of an inductive coupled plasma torch.

In some embodiments, the fuel that is produced may be ethanol. In some embodiments, the method may also involve centrifuging the combustion gas exhaust to remove from the combustion gas exhaust the particulates that are present within the combustion gas exhaust. The method may involve, prior to the step of further lowering the temperature, removing water that is part of the pressurized gas that has condensed. The producing of the fuel may be performed using at least one of solar power and wind power as the intermittent renewable power source. The method may also include utilizing a heat pump to further cool the pressurized gas to below −15 degrees Celsius, and preferably to below −25 degrees Celsius. The compressing may result in a pressurized gas with a pressure in the range of 18 bar to 50 bar, preferably between 24 bar and 35 bar.

In some embodiments, the method may also include combusting the produced fuel to produce electrical power. The combusting of original fuel and the combusting of the produced fuel may be to produce a set amount of electrical power, and wherein the electrical power produced from the combusting of produced fuel may result in the lowering of the combustion rate of the original fuel. The method may also include producing electrical energy from the pressurized gas, once the liquefied carbon dioxide has been separated from the pressurized gas, by expanding the pressurised gas and by using a compressed-gas motor generator. The method may also include heating the pressurized gas prior to or during the expanding of pressurized gas.

### BRIEF DESCRIPTION OF THE DRAWINGS

The invention will be better understood by way of the following detailed description of embodiments of the invention with reference to the appended drawings, in which:

FIG. 1A is a modular block diagram of an exemplary electrical power generation system.

FIG. 1B is a diagram of an exemplary electrical power generation system.

FIG. 2 is a schematic block diagram of a CAES system that collects CO2 in the compressed air, and then uses surplus power to transform CO2 into fuel gas for additional power storage as fuel gas.

FIG. 3A is the phase diagram of CO2;

FIG. 3B is the phase diagram of nitrogen;

FIG. 4 is a schematic diagram of an inductive plasma assembly showing the three concentric tubes composing the torch, the RF coil, the different plasma regions, and the temperature as a function of height above the load coil;

FIG. 5 is a schematic diagram of CAES compressed air storage tanks inclined to collect CO2 condensate;

FIG. 6 is a schematic diagram of the CO2 capture, transformation and storage (CCTS) setup; and

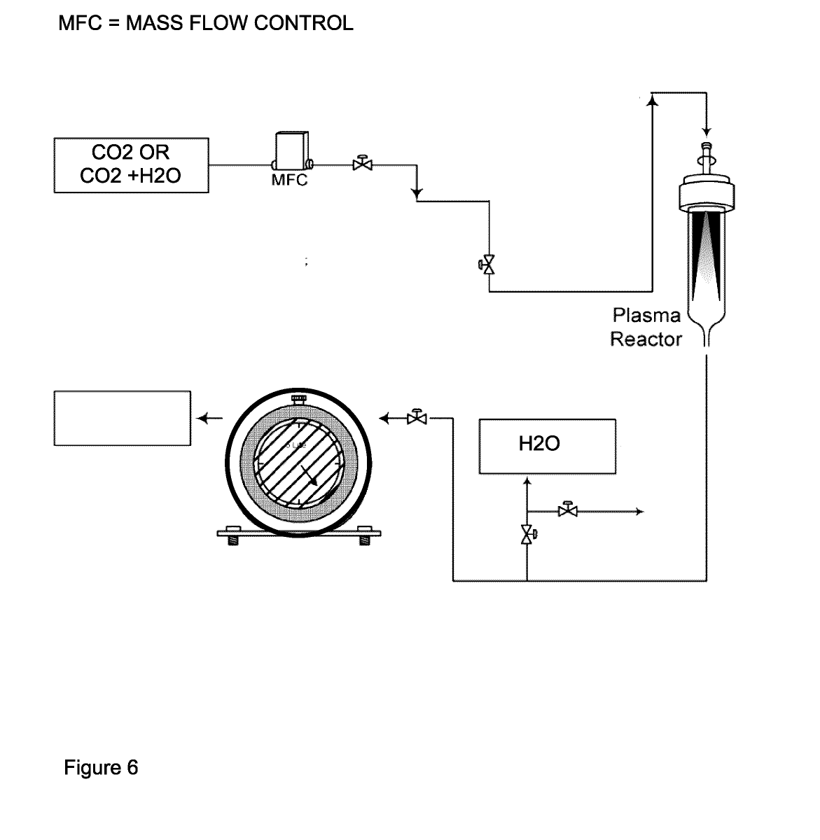

FIG. 7 is a graph illustrating the percent of carbon dioxide liquefaction in a gas mixture of 12%-15% carbon dioxide, where the partial pressure of carbon dioxide is around 30 bar, as a function of temperature.

FIG. 8 is a block diagram of an exemplary controller connected to a power grid and an exemplary electrical power generation system.

FIG. 9 is a flowchart diagram of an exemplary method for storing and converting carbon dioxide produced through combustion into a fuel.

### DETAILED DESCRIPTION

CO2 capture and disposal from flue gas streams has been considered as a technically feasible but costly option for the reduction of CO2 emissions into the atmosphere. CO2 capture is the major cost component. Therefore, there is considerable incentive in finding energy efficient, and thus less costly, processes for the capture of CO2 as compared to the conventional monoethanolamine (MEA) based processes. The present system utilizes certain strategies to leverage on the energy consumption of the CAES compressors to lower the cost of capturing CO2, simplifying its capturing, and all while it can minimize the amount of equipment required.

The system is particularly beneficial in northern territories, where diesel and gasoline generators play an important role in energy production for communities living in these regions For instance, in northern parts of Canada, diesel and gasoline generators are a significant source of electrical power for communities living in these areas as shown in Table 1:

TABLE 1
comparison of the number of MWh produced by different
sources of electrical energy in Canada's territories.

| Source | Unit | Yukon | Northwest | Nunavut |
|---|---|---|---|---|
| Combustion | MWh | 0 | 6,196 | 0 |
| Turbine | | | | |
| Diesel/Gasoline | MWh | 22,601 | 396,727 | 181,280 |
| Generators | | | | |
| Solar | MWh | 0 | 112 | 0 |
| Wind | MWh | 277 | 19,854 | 0 |
| Hydraulic | MWh | 404,937 | 222,982 | 0 |

The gas emissions resulting from diesel combustion (DCGE) may contain Nitrogen (N2), Oxygen (02), Water (H2O), Carbon dioxide (CO2), Carbon monoxide (CO), Nitrogen oxides (NOX), Sulfur Dioxide (SO2), Lead (Pb), Hydrocarbons (HC), Soot particles (SP). As shown in the table I only N2, CO2, H2O and O2 represent about 99.7% of the DCGE. The other species will be neglected in the performed calculations.

TABLE 2
Temperature Range from Diesel Engine

| Combustion-engine exhaust gases | Chemical | % of total |
|---|---|---|
| Compound | symbols | Diesel |
| Nitrogen | N₂ | 67 |
| Carbon dioxide | CO₂ | 12 |
| Water vapor | H₂O | 11 |
| Oxygen | O₂ | 10 |
| Trace elements | | ~0.3 |
| Nitrogen oxides | NO_{X} | <0.15 |
| Carbon monoxide | CO | <0.045 |
| Particulate matter | PM | <0.045 |
| Hydrocarbons | HC | <0.03 |
| Lead | Pb | <0.01 |
| Sulphur dioxide | SO₂ | <0.03 |

The present system seeks to capture and store carbon dioxide produced during combustion. The main components of the CO2 capture and storage system (CCS) include the capture (separation and compression), transport and storage (including measurement, monitoring and verification) of carbon dioxide.

The present combustion and carbon dioxide storage and conversion system compresses and stores at least a portion of exhaust gas by using a percentage of the energy produced from the motor and the heat of the gas. The compressed and stored carbon dioxide can then be transformed and used, for instance, as a source of fuel. The transformation process of the carbon dioxide into fuel may be limited to periods when an intermittent energy source is available, such as solar power or wind power. The carbon dioxide may be converted into carbon monoxide or ethanol as fuel, as described herein.

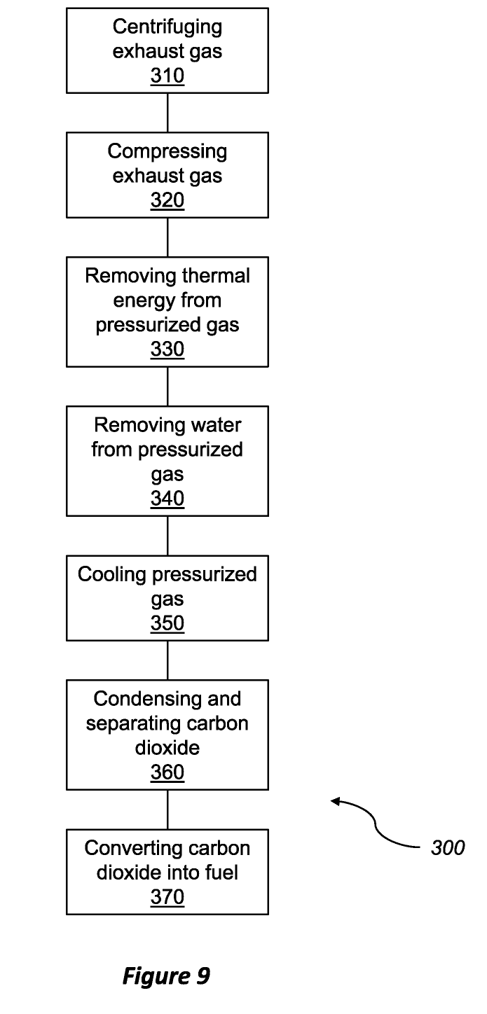

Reference is now made to FIG. 9, illustrating an exemplary method 300 of converting carbon dioxide produced during combustion into a fuel. The exhaust gas from a combustion prime mover is first captured. The captured exhaust gas may be optionally passed through a heat exchanger to capture the thermal energy of the exhaust, storing the thermal heat for future use, lowering the temperature of the exhaust gas in the process.

The exhaust gas is then passed through a centrifuge or a filter to remove particulates floating in the gas at step 310. The exhaust gas is then passed in a compressor, increasing the pressure of the exhaust gas (e.g. anywhere between 30 bar to 200 bar—however, compressing to a higher pressure requires more energy, and when the compression energy is sourced from the electrical energy produced by the combustion motor, preferably less of the electrical energy is directed to the process of compressing to have a more efficient system—in some embodiments, one tenth of the electrical energy produced by the electrical generator and combustion motor may be used to compress the exhaust gas).

The compression results in pressurized gas and thermal energy. The pressurized gas is then passed through a heat exchanger to extract the thermal energy at step 330, lowering the temperature of the pressurized gas. The thermal energy may then be stored for later use, such as to power a cooling unit to further lower the temperature of the pressurized gas.

Following the compressing and lowering of the temperature of the gas, water can then be condensed and removed from the pressurized gas at step 340. Additional cooling and/or compression may be required to condense most if not all of the water.

The pressurized gas is then further cooled at step 350. This may be done by utilizing the cold temperature of the air when the system is installed in northern territories during a cold time of year. A heat exchanger may be used to evacuate the heat of the pressurized gas, utilizing the cold ambient air as a heat sink. Alternatively, a cooling unit may be used to lower the temperature of the pressurized gas. Preferably, the temperature of the pressurized gas is lowered at least to −15° C.

The cooled and compressed gas will result in at least partial liquefaction of the carbon dioxide. The carbon dioxide may then be separated from the pressurized mixture at step 360. The carbon dioxide may then be stored, or immediately transformed into a fuel (e.g. carbon monoxide or ethanol) for future use as explained herein. The remaining pressurized gas may also be stored at high pressure, and/or used as a source of energy using a turbine and a compressed air energy generator as the gas expands.

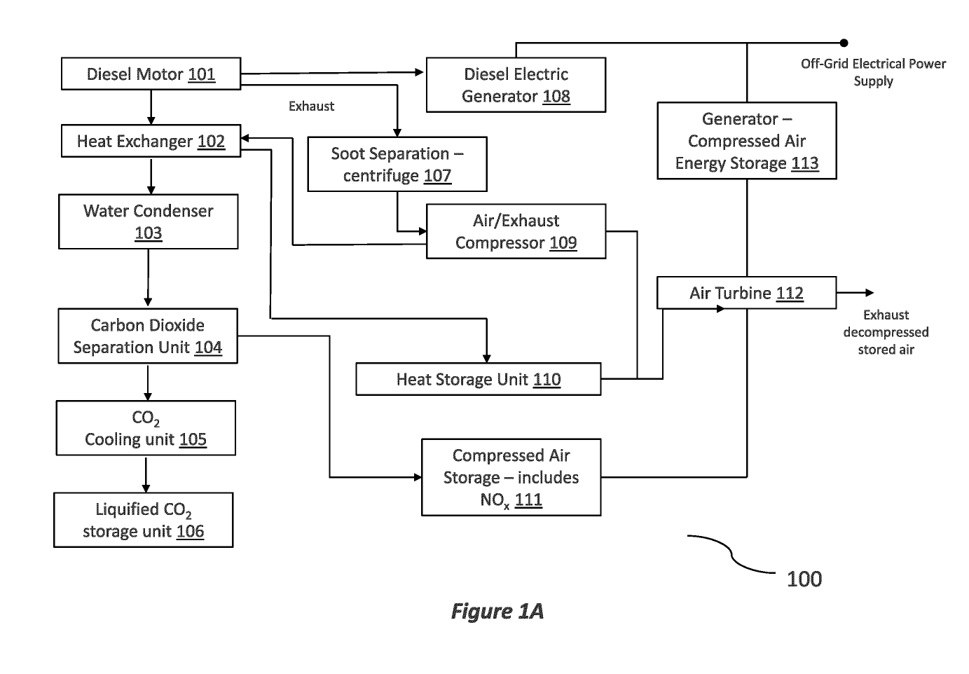

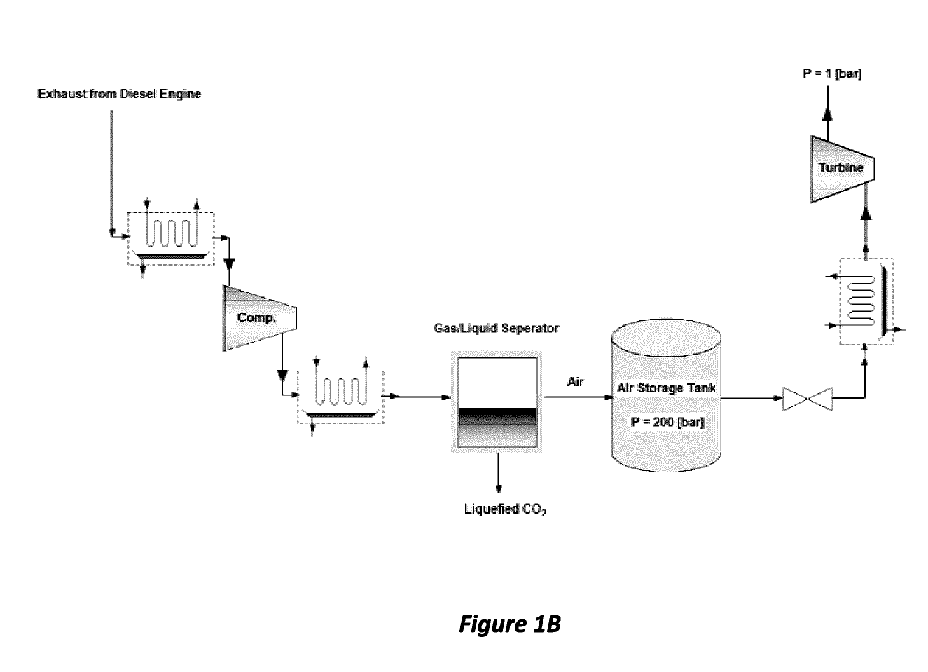

Reference is now made to FIG. 1. FIG. 1A is a modular block diagram of an exemplary system for combusting fuel to produce electrical energy, capturing and storing carbon dioxide 100 from the exhaust of an engine 101. In some embodiments, the engine 101 may be an internal combustion engine or a diesel engine, but it will understood that any source of exhaust as a result of combustion may be used. The prime mover may be that, for instance, of a factory, an outdoor generator, or that of a moving motorized vehicle (e.g. a car, truck, snowmobile). The engine 101 may be run with an electric generator 108, the generator connected to, for instance, an off-grid electrical power supply for producing electrical energy as a result of fuel combustion. As the engine 101 runs, it combusts higher alkanes into a mixture of gases, namely carbon dioxide, water, nitrogen, nitrous oxide, leaving some residual oxygen. In the case of a standard diesel engine, the partial pressure of carbon dioxide in the exhaust mixture is around 0.16 bar (where of the exhaust emissions of diesel or gasoline engines is of about 12-15% of carbon dioxide).

This exhaust (the gas mixture) is used as the intake for an air compressor 109, where these gases are passed in the air/exhaust compressor 109. Before reaching the air compressor 109, the gas mixture may first pass through a centrifuge 107 for extracting soot particulates floating in the gas. The centrifuge 107 relies on centripetal acceleration to separate molecules as a function of their mass and can be used with most fluids (e.g. a gas or liquid). In some embodiments, the gas may be passed through the centrifuge 107 before the compressor 109. In other embodiments, a filter may be used to remove the particulates instead, or in addition to, the centrifuge 107.

The air compressor 109 then compresses the exhaust air mixture, increasing the pressure of the air mixture. The energy of compression is transformed into two forms, namely potential energy due to compression and thermal energy. The thermal energy is then captured using a heat exchanger 102, where, for instance, a heat transfer fluid is used for storing the heat extracted from the compressed air, lowering the temperature of the gas mixture and thus for extracting heat. The thermal energy extracted from the gas mixture may be stored in a heat storage unit 110 and may later be converted into electrical energy using, for instance, a waste heat recovery unit. The heat exchanger may lower the temperature of the pressurized gas to ambient temperature.

In some examples, as shown in FIG. 1B, there may be a first heat exchanger receiving the exhaust gas mixture generator from the combustion energy prime mover (e.g. the exhaust from the diesel engine) that lowers the temperature of the unpressurized exhaust before the exhaust first reaches the compressor. In some other examples, the diesel motor 101 may be connected to a heat exchanger, where the excess heat produced by the diesel motor 101 may be recovered, stored (e.g. in the heat storage unit 110), and used later.

The reduction of the temperature of the pressurized gas, and the compression of the gas, may result in water condensation. As a result, water may be extracted from the gas mixture using a condenser 103. If necessary, water may be extracted by further compressing the gas, increasing the pressure of the mixture. Water condensation augments as the pressure of the mixture is increased and the temperature of the gas mixture decreases. Removal of water increases the partial pressure of the carbon dioxide in the mixture. In some examples, once the exhaust air has been compressed and cooled to room temperature, where the water has condensed out of the gas mixture, the partial pressure of carbon dioxide in the pressurized gas mixture would be around 26-30 bar.

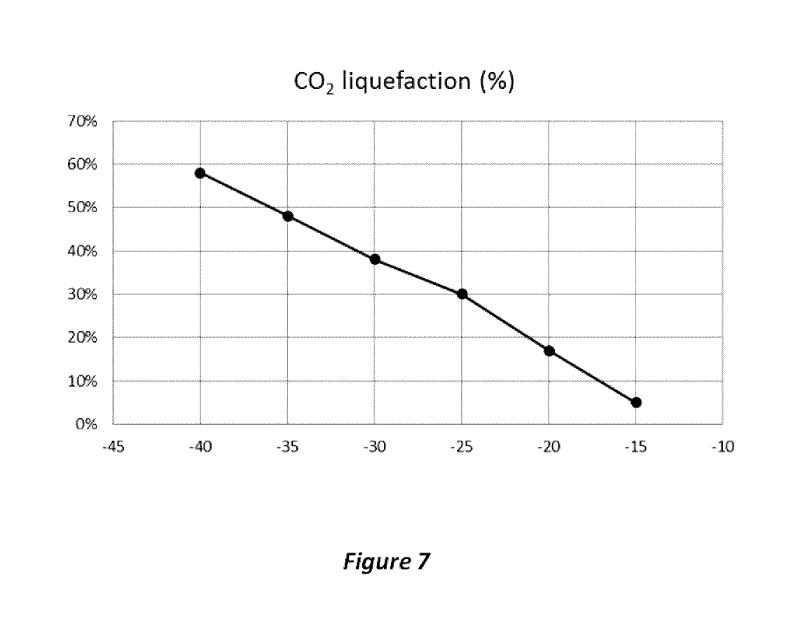

At this pressure of carbon dioxide, the saturation temperature where there is a significant carbon dioxide liquefaction as shown in the graph of FIG. 7, ranges between −40° C. and −15° C., where the % of liquefaction of the carbon dioxide ranges respectively at these temperatures from just under 60% to around 5%.

Carbon dioxide is then separated from the compressed gas mixture. Separation of the carbon dioxide from the gas mixture may be achieved using another heat exchanger 105 or heat pump 105, lowering the temperature of the mixture to a point where a certain amount or ratio of liquid carbon dioxide may be achieved. This phase change of carbon dioxide allows for the extraction of carbon dioxide from the gas mixture. The liquefied carbon dioxide may then be extracted and stored in a storing unit 106. Liquefying does not require as low temperatures as if the gas was, for example, at atmospheric pressure, due to the high pressure of the carbon dioxide gas.

In a preferred embodiment, the system 100 may be placed in a cold environment where the ambient temperatures range around −15 degrees Celsius at some periods of the year. In this environment, the cooling unit 105 is unnecessary (or can be used additionally to the natural cooling resulting from the ambient temperature or when the ambient temperature is higher), as the ambient temperature of the air will sufficiently cool the gas mixture to liquefy a certain amount of carbon dioxide. In another embodiment, the pressurized gas may be cooled further using a heat pump to extract and dispel the heat, where the system 100 may be used in warmer regions. In some embodiments, a heat exchanger connected with the ambient air may be used to lower the temperature of the pressurized gas by using the ambient air as a form of heat sink, ridding the excess heat. In some embodiments, where the exemplary system 100 is used in colder climates, such as those of Nunavut and Yukon, the system is capable of obtaining a significant percentage of liquefaction of carbon dioxide during several months of the year by using the cold weather of the climate to lower the temperature of the carbon dioxide rich gas to liquefy a portion of the carbon dioxide, as shown in the following table:

TABLE 3
amount of liquid carbon dioxide produced by a 900
kW diesel engine with a 37% efficiency, producing
238.4 L/h of exhaust gas at a 100% load with fan (producing
around 1 kg of exhaust gas per second.)

| Region | | Jan | Feb | Mar | Apr | Nov | Dec |
|---|---|---|---|---|---|---|---|
| Clyde | Temperature [C.] | −32 | −33 | −32 | −25 | −21 | −28 |
| River, | CO₂ liq. (%) | 43 | 46 | 43 | 30 | 19 | 35 |
| Nunavut | CO₂ (g/s) | 82.7 | 88.5 | 82.7 | 57.7 | 36.5 | 67.3 |
| | CO₂ (kg/kWh) | 0.3 | 0.4 | 0.3 | 0.2 | 0.1 | 0.3 |
| | CO₂ (kg/L) | 1.2 | 1.3 | 1.2 | 0.9 | 0.6 | 1.0 |
| Watson | Temperature [C.] | −30 | −25 | −19 | −7 | −21 | −28 |
| Lake, | CO₂ liq. (%) | 38 | 30 | 15 | 0 | 19 | 35 |
| Yukon | CO₂ (g/s) | 73.1 | 57.7 | 28.9 | 0 | 36.5 | 67.3 |
| | CO₂ (kg/kWh) | 0.3 | 0.2 | 0.1 | 0.0 | 0.1 | 0.3 |
| | CO₂ (kg/L) | 1.1 | 0.9 | 0.4 | 0.0 | 0.6 | 1.0 |

The liquefied carbon dioxide may then be removed from the condensing chamber, this pushing more carbon dioxide to change state from gas to liquid as more of the gas mixture is introduced into the condensing chamber. In some embodiments, the liquefied carbon dioxide may be stored in storage units.

The remaining gas from the gas mixture (e.g. residual water, nitrogen, nitrogen oxide and some oxygen) may be sent to a compressed air storage tank 111. In some examples, the air storage tank may store the gas at a pressure of 200 Bar, as shown in the example of FIG. 1B. The stored gas may be utilized when needed to be used in the turbine 112 and compressed-air energy generator 113, to produce electrical energy, when expanded. In some other examples, the remaining compressed gas may be immediately evacuated using an air motor or turbine 112, where the compressed air passing through the turbine 112 may expand and the expansion leading to the production of electrical energy, such as by the compressed air energy-generator 113. The air exiting the turbine 112 may be at or near atmospheric pressure. Prior to passing through the turbine, the compressed air may first pass through a heat exchanger, where, for instance, the heat stored in the heat storage unit 110, may be used to provide the compressed air with thermal energy. The stored heat may be, for instance, that of the initial exhaust or the thermal energy produced and removed by heat exchanger 102 when the exhaust is compressed. In some examples, more than one turbine 112 may be used, where the expansion of compressed gas may be done gradually, where, optionally, prior to each expansion stage, there may be a heat exchanger to inject thermal energy back into the pressurized gas mixture.

In some embodiments, the electrical energy may be stored in an off-grid electrical power supply or recirculated in the system 100 to power the system 100 (e.g. the compressor 109 and centrifuge 107). Therefore, the following system 100 may be self-sustaining, where the energy collected from the exhaust fumes may be captured and reused to power the system 100.

The liquefied carbon dioxide may be transformed into fuel as explained herein. The produced fuel may be either ethanol or carbon monoxide. The energy used to produce the fuel may originate from an intermittent energy source, and may produce solar power or wind power. As a result, the process of converting the carbon dioxide into fuel may be timed with the presence of such intermittent power, such as when there is a blue sky, or heavy wind at night. The fuel can be stored once produced, and utilized, for instance, when power consumption needs increase or demand its use. The intermittence of the conversion of the carbon dioxide into fuel results in a more sustainable system, where available renewable energy is harnessed and is the source of the power required to create the fuel.

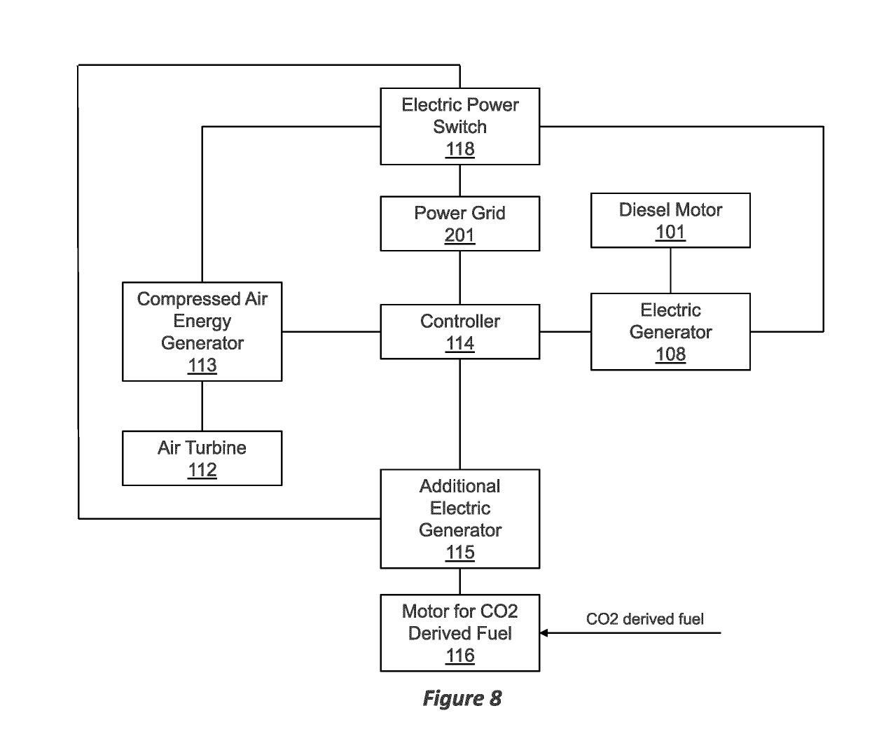

Moreover, in some embodiments, as shown in FIG. 8, the system 100 may have electrical power switching equipment 118 for switching between the use of the compressed air energy generator 113 combined with the air turbine 112 and the electrical generator 108 combined with the motor 101. The electrical power switch 118 is connected to the power grid 201. This switching from one energy source to the other may be seamless or nearly seamless, where the switching between one to the next may be done without interruption. As a result, the use of the compressed air energy generator 113 may reduce the load of on electric generator 108 and motor 101 (such as by reducing the fuel to be combusted by motor 101), or assist the motor 101 and electric generator 108 during periods of the year where there are increased power requirements. Therefore, the electrical power switching equipment 118 may also connect or disconnect electrical power produced by the compressed air energy generator 113 combined with the air turbine 112 to the local power grid 201 to increase a power supply to the local power grid 201 during peak demand. This may be the case when the temperature drops significantly, and a community requires additional heating to stay warm.

In some embodiments, the compressed air energy generator 113 may have a gas motor connected to a shaft of the electrical generator 108 that is connected to the primer mover (e.g. diesel motor 101). In other embodiments, the compressed air energy generator 113 may have its own electric generator, distinct from that of the motor 101.

In some embodiments, the system 100 may have a controller 114 that is connected to the local power grid 201. The controller 114 senses a load demand of the local power grid and causes the compressed air energy generator 113 to generate electrical power to the local power grid 201, the pressurized air passing through the turbine 112 to do work.

In some embodiments, in periods where the power load needed increases (such as in peak periods), the controller 114 may also signal the system 100 to cease for a designated period the compression of the exhaust, as the compression of the exhaust gas by the compressor 109 may be utilizing electrical energy produced by the motor 101 and electric generator 108. The compressor 109 may then be switched back on when the demand for power drops. Similarly, other components of the system 100, requiring electrical energy to run, may also be switched off for a given period during peak periods or when power demands increase.

In other embodiments, the controller 114 can also be connected with an electrical generator 115 connected with the combustion prime mover 116 of the fuel produced from the carbon dioxide. In some embodiments, the motor 101 and electrical generator 108 may also be that responsible for combusting and generating electrical energy from the carbon dioxide derived fuel. Similarly to the case of with the compressed air energy generator 113, the controller 114 may sense an increased demand of the local power grid and prompt the combustion of carbon dioxide derived fuel to meet the demand. The controller 114 may also signal that the combustion of carbon dioxide derived fuel is to cease.

CO2 Capture at Very High Pressure and Room Temperature and Transformation into Carbon Monoxide

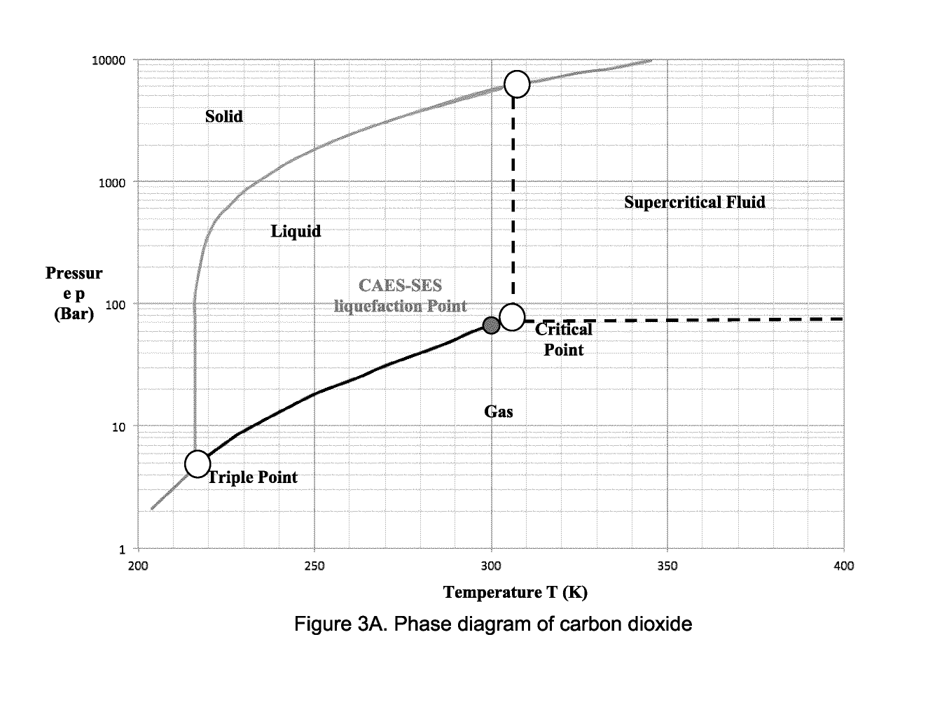

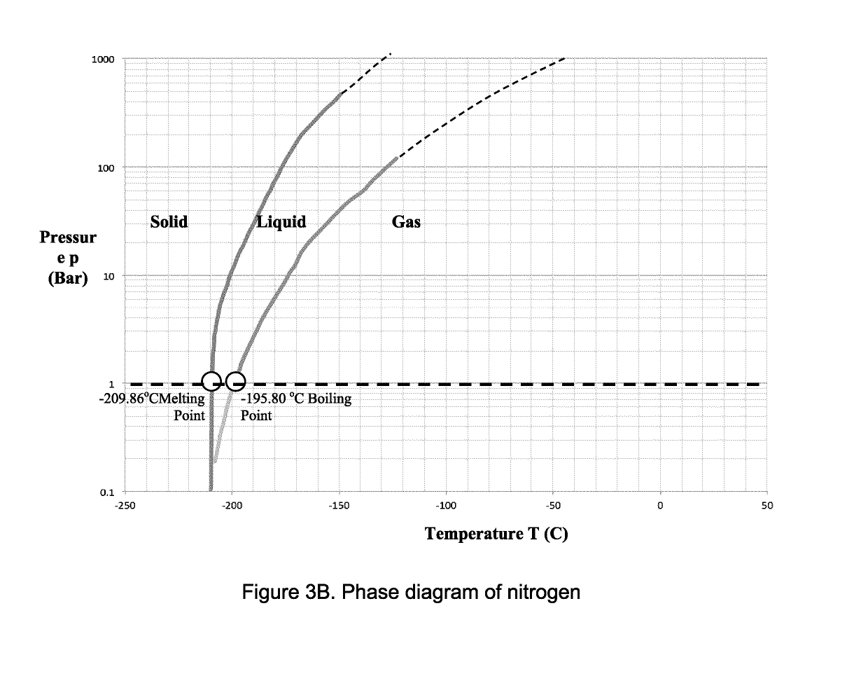

In this embodiment, CO2 capture, transformation and storage (CCTS) is used instead of CCS. In the CAES, especially in the CAES-SES (compressed air energy storage developed by Sigma Energy Storage) air is stored at very high pressure (more than 400 bars). In this process, the DCGE is used as an inlet admission gas for the CAES-SES. After the heat recovery at the heat exchanger the temperature of the DCGE at the vessels inlet are at around of the room temperature. At the room temperature and over 400 bars, according to the phase diagram of the CO2 (FIG. 3A), the CO2 is in the liquid state (liquefaction start at 60 bars at room temperature). At room temperature and over 400 bars, nitrogen is still in its gaseous state (FIG. 3B) and H2O in its liquid state. In some embodiments, where water has not been condensed from the pressurized gas mixture, after DCGE storing, only CO2 and H2O are in liquid phase which allows easy separation by gravity.

In these embodiments, the high-pressure storage vessels are set with a small inclination angle to the horizontal floor level and a last vessel is connected at lower level compared with the others. Each vessel is connected by series with the other which allows the accumulation of the liquid phases at the last vessel due to the pressure and the flow from the compressed through all vessels. This configuration allows having a single location with a liquid phase, which thus facilitates its purge. Thereby, CO2 and H2O in liquid form can be accumulated in the lower level vessel using only the gravitational forces. The purge will also allow for the evacuation of the liquid phase from the last lower vessel to another vessel called phase change tank by opening a solenoid-valve. The purge ends when the phase sensor detects the gas phase at the outlet purge point. The pressure in the purge vessel will drop down under 60 bars which allows to CO2 changing its phase to gas and prepare it for transformation to CO, the H2O remains liquid. The separation of the CO2 and H2O can be done with gravity to out recipient using the same technique as previews or waiting until the transformation of the CO2 to CO with the plasma torch. CO2 can be recompressed to the liquid state again at a pure state after purging H2O if the carbon dioxide is not yet to be transformed into fuel.

CO2 Transformation to a Fuel CO Using Inductive Coupled Plasma Torch (ICP)

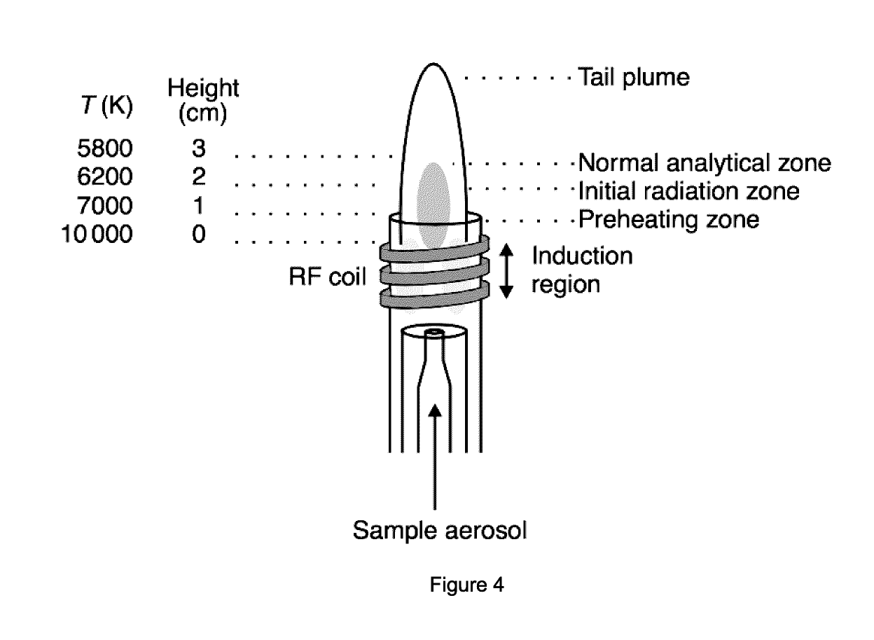

A plasma flow generated in an ICP torch gives a high-temperature environment (5000 to 10 000 K) with a high specific enthalpy (1-10 MJ/kg, depending on the plasma gas composition) (FIG. 4). The central axial feeding system provides a more flexible and efficient approach than direct current plasma torches (DCP). Because the residence time is longer than in DCP, the precursor is better treated and the particles are heated thoroughly.

The main analytical advantages of the ICP over other excitation sources originate stems from its capability for efficient and reproducible vaporization, atomization, excitation, and ionization of a wide range of elements in various sample matrices. This is mainly due to the high temperature, 5,000-10,000 K, in the observation zones of the ICP. This temperature is much higher than the maximum temperature of flames or furnaces (3300 K). The high temperature of the ICP also makes it capable of exciting refractory elements, and renders it less prone to matrix interferences. Other electrical-discharge-based sources, such as alternating current and direct current arcs and sparks, and the microwave induced plasma (MIP), also have high temperatures for excitation and ionization, but the ICP is typically less noisy and better able to handle liquid samples as H2O if no purged from the purge vessel. In addition, the ICP is an electrodeless source, so there is no contamination from the impurities present in an electrode material. Furthermore, it is relatively easy to build an ICP assembly and it is inexpensive, compared to some other sources, such as a laser-induced plasma (LIP).

Induction plasma can be easily characterized by the presence of the flame in the axe if the coil. This flame is created as an effect of an electromagnetic force ionizing the carbon dioxide gas. The flame and the maximum temperature depend from the relative distance from the load coil. A few centimeters above the coil, as shown in FIG. 4, the temperature is still high but not as high as inside the coil, resulting from the high velocity of the gas penetration. Induction plasma may be used in chemical reactions, such as pollutant decomposition, etc. where Gliding arc plasma can be used. The gliding arc plasma is classified as cold plasma; and it possesses some of the characteristics of thermal (hot temperature) plasma. The plasma-combustion process may also occur in the gliding arc plasma process. In some embodiments, due to the higher temperature in the inductive plasma, the inductive plasma is preferred for pure CO2 gas injection. This characteristic is one advantage of decomposing toxic and dangerous gases that usually have strong bonds or chemical structure, such as in the case of CO2.

In this embodiment, the purge vessel feeds the inductive plasma axially.

CO2 Gas Introduction

A CO2 introduction system is used to transport CO2 into the central channel of the ICP as a gas with or without H2O liquid or vapor.

Chemical Reaction and CO Production

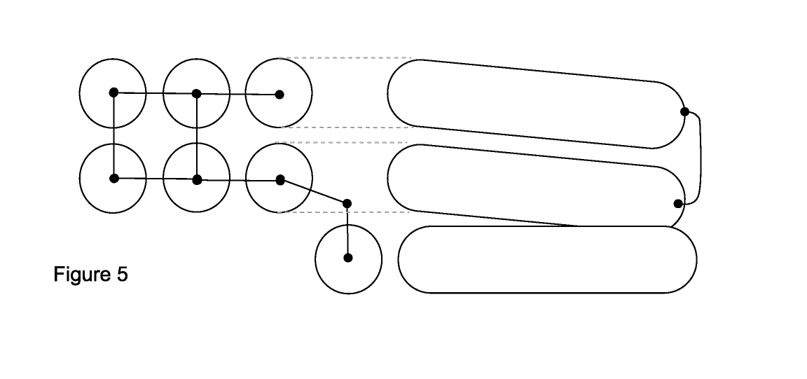

The schematic diagram of the CCTS setup is shown in FIG. 5. CO2 is used as the main input gas with purity of 99% if H2O is purged before transformation. If water is still present, the purity may range at about 50%. The input of carbon dioxide may be controlled by a mass flow rate controller. In some embodiments, the total flow rate is about 2 L/min. The flow rate may also be controlled by the specifications of a mass flow controller. To maintain the mass flow rate constant, a solenoid-valve may be installed between the purge vessel and the plasma torch. The composition of the outlet mixture may be automatically analyzed before and after the plasma reaction. Before an analysis by gas chromatography (GC), the flow rate of CO2 is measured in real time.

In some examples. the reactor may be made from a quartz-glass tube. A water cooler system may be used to control the plasma parts temperature.

The main reaction after passing through the plasma coil is:

2CO₂ [symbol] 2CO₂⁻+2e⁻ [symbol] 2CO+2O⁻+2⁻ [symbol] 2CO+O2+2⁻ (1)

Although CO is also categorized as a toxic gas; the CO molecule is more reactive than CO2 makes for a better fuel. Through the reaction with electrons, the plasma reaction can be separated into two steps: (1) direct reaction which produced CO and 02, and (2) a separation process conducted to separate O2 from CO.

Availability and Recovery of Waste Heat from Diesel Engines

The quantity of waste heat contained in an exhaust gas is a function of both the temperature and the mass flow rate of the exhaust gas:

\dot{Q}=\dot{m}×Cₚ×ΔT

Where, \dot{Q} is the heat loss (kJ/min); \dot{m} is the exhaust gas mass flow rate (kg/min); Cₚ is the specific heat of exhaust gas (kJ/kg° K); and ΔT is temperature gradient in ° K. In order to enable heat transfer and recovery, it is necessary that the waste heat source temperature is higher than the heat sink temperature. Moreover, the magnitude of the temperature difference between the heat source and sink is an important determinant of waste heat's utility or “quality”. The source and sink temperature difference influences the rate at which heat is transferred per unit surface area of recovery system, and the maximum theoretical efficiency of converting thermal from the heat source to another form of energy (i.e., mechanical or electrical). Finally, the temperature range plays an important role in the selection of waste heat recovery system designs.

Table IV shows a non-Exhaustive survey, made from measurements of exhaust temperature from internal combustion engines of automotive vehicles and stationary engines.

TABLE IV
Non Exhaustive Examples of Temperature Range from Diesel Engine
(Other types of thermodynamic engines are possible)

| Sr. No. | Engine | Temperature in ° C. |
|---|---|---|
| 1 | Single Cylinder Four Stroke Diesel Engine | 456 |
| 2 | Four Cylinder Four Stroke Diesel Engine | 448 |
| | (Tata Indica) | |
| 3 | Six Cylinder Four Stroke Diesel Engine | 336 |
| | (TATA Truck) | |
| 4 | Four Cylinder Four Stroke Diesel Engine | 310 |
| | (Mahindra arjun 605 DI) | |
| 5 | Genset (Kirloskar) at power 198 hp | 383 |
| 6 | Genset (Cummims) at power 200 hp | 396 |

Heat Loss Through the Exhaust in Internal Combustion Engine

Heat loss through the exhaust gas from internal combustion is calculated as follows. Assuming,

Volumetric efficiency (η_{ν}) is 0.8 to 0.9
Density diesel fuel is 0.84 to 0.85 gm/cc
Calorific value of diesel is 42 to 45 MJ/kg
Density air fuel is 1.167 kg/m
Specific heat of exhaust gas is 1.1-1.25 KJ/kg° K
Exhaust heat loss through diesel engine Compression ratio (Vᵣ)

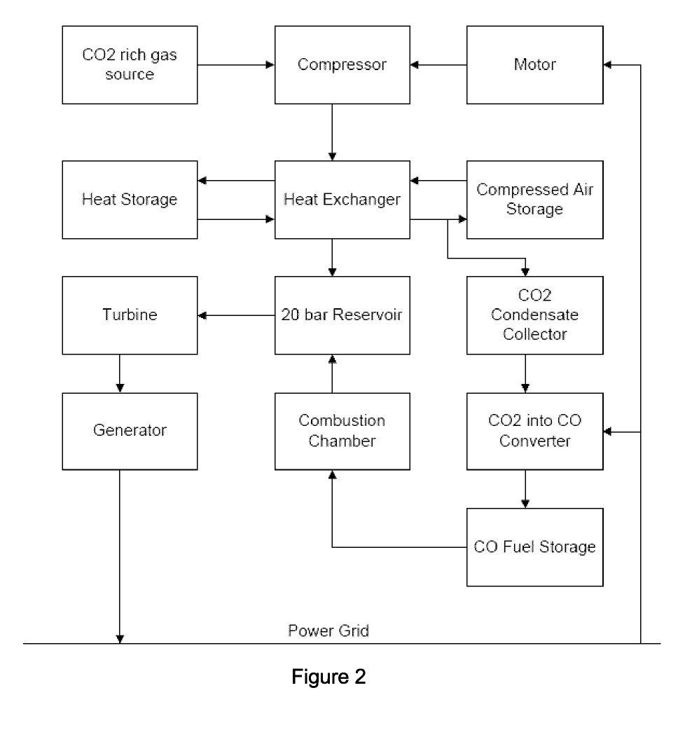

FIG. 2 is a schematic block diagram of a CAES system that collects CO2 in the compressed air, and then uses surplus power to transform CO2 into fuel gas for additional power storage as fuel gas. The CAES system may comprise any one of the CAES configurations as described in Applicant's PCT Publication WO2014/161065 published on 9 Oct. 2014, the specification of which is hereby incorporated by reference.

In FIG. 2, the CO2 condensate from air compression is collected. The compressed air can be ambient air having a normal content of 0.04% by volume, or preferably, it can be exhaust gas from combustion of a fossil fuel. As described above, diesel exhaust has about 12% CO2 by volume. The CO2 captured by a CAES unit can be used locally or transported to an installation that will use it.

As illustrated, CO2 is converted into CO and oxygen in a converter using input energy. This input energy can be from a power grid, for example, or from an intermittent energy source (e.g. solar or wind). The fuel gas obtained can be stored in a storage reservoir as is conventionally done for fuel gas.

When the CO fuel storage is locally done at a CAES installation, the fuel gas can be fed to a combustion chamber separate from or integrated with an air reservoir of the CAES system that feeds high pressure gas to a turbine (or other motor) to generate electricity. As will be appreciated, in the reaction of 2CO+O2=2CO2, heat is provided without increasing the number of molecules of gas. Pressure increase is a result of the increase in temperature. When the stored compressed air is expanded, the added heat from CO combustion expands the uncompressed air to greater pressure, so that more work efficiency in the turbine is possible.

As will be appreciated, the generation of fuel gas from CO2 is an efficient means to store energy provided that there is an abundant supply of readily available CO2. The combination of CO fuel gas generation with a CAES system as a source for the supply of CO2 is efficient. The use of heat from combustion of the CO fuel gas in CAES regeneration is also efficient as the additional thermal energy is a boost to the work done by the air in the turbine.

In some other examples, the liquefied carbon dioxide may instead be converted into ethanol as fuel, as disclosed in Yang Song et al. “High-Selectivity Electrochemical Conversion of CO₂ to Ethanol using a Copper Nanoparticle/N-Doped Graphene Electrode”, ChemistrySelect 2016, 1, 6055-6061.

The fuel produced from the carbon dioxide may be stored and combusted using a combustion energy prime mover connected to, for instance, an electrical generator, when additional energy is so required.

In some examples, the electrical energy produced by the combustion of the produced fuel may allow for the original engine (e.g. diesel motor 101) to combust less of the original fuel, as the combusting of the produced fuel from the carbon dioxide is producing a portion of the necessary electrical energy. This may reduce the load from the diesel motor 101, or assist the diesel motor 101 in producing electrical energy in particularly energy consuming periods of the year, such as in very cold periods of the year. Similarly, the expanding of the pressurized gas using the air turbine 112 and the electrical energy produced therefrom using the compressed air energy-generator 113 may equally assist the diesel motor 01 and electric generator 108 in producing additional electrical energy.

The heat stored in the heat storage unit 110 is also not wasted, and may also be used for district heating, such as heating certain buildings or portions thereof. In other examples, the heat stored in the heat storage unit 110 may be used to power a cooling unit to further lower the temperature of the pressurized flue gas, improving the carbon dioxide capture via its liquefaction.

### Quantity of Exhaust Produced by Generators:

The following illustrates the amount of emissions produced by certain generators.

Table 5 quantifies heat rejection and emissions of certain generator models, based on manufacturer's specifications:

TABLE V
heat rejection and emissions of certain generator
models, based on manufacturer's specifications.

| | | Heat Rejection (kW) | | | | | Emission (mg/m³) | | | |
|---|---|---|---|---|---|---|---|---|---|---|
| | Power | | | After | | | | | | Part |
| Model | (kW) | Coolant | Exhaust | Cooler | Ambient | Total | NO_{X} | CO | HC | matter |
| C32-1100 | 800 | 319 | 818 | 181 | 177 | 1495 | 1938 | 100 | 11 | 12 |
| MD1000 | 1000 | 417 | 850 | 328 | — | 1595 | — | — | — | — |
| DQFAD | 1000 | 815 | 884 | — | 158 | 1857 | 1267 | 135 | 88 | 69.47 |
| 16V4000 | 2045 | 710 | 1100 | 260 | 90 | 2160 | — | — | — | — |

The average rejection of CO2 in gaseous form is calculated for the generators in Table V. This was done by assuming that a diesel combustion engine rejects on average between 12% and 14% of volumetric ratio of CO2. The volumetric rate for carbon dioxide was then calculated from the total volumetric flow out of the exhaust. Finally, the rate for CO2 was multiplied by its density at the outlet conditions, which are approximately 0.16 bar (partial pressure) and 500° C. The average mass flow rate is thus 3 to 4 kg of CO2 per minute.

The present description has been provided for purposes of illustration but is not intended to be exhaustive or limited to the disclosed embodiments. Many modifications and variations will be apparent to those of ordinary skill in the art.

What is claimed is:

1. An electrical power generation system comprising:
a combustion energy prime mover having a combustion gas exhaust;
an electrical generator connected to said prime mover connectable to a local power grid;
a gas compressor receiving said combustion gas exhaust and providing pressurized gas and gas compression heat; and
a liquid carbon dioxide collector for collecting liquid carbon dioxide from said pressurized gas.

2. The power generation system as defined in claim 1, further comprising:
a heat exchanger sub-system in communication with said gas compression heat for heat storage or district heating.

3. The power generation system as defined in claim 2, wherein said heat exchanger sub-system is in communication with a cooling system of said combustion energy prime mover.

4. The power generation system as defined in claim 1, further comprising:
a compressed gas motor-generator subsystem for generating electrical power from said pressurized gas.

5. The power generation system as defined in claim 2 or 3, further comprising:
a compressed gas motor-generator subsystem for generating electrical power from said pressurized gas, wherein said heat exchanger sub-system comprises a heat exchanger for heating said pressurized gas before or during expansion.

6. The power generation system as defined in claim 4 or 5, further comprising electrical power switching equipment connected to said local power grid for switching over electrical power between said compressed gas motor-generator subsystem and said electrical generator connected to said prime mover without interruption.

7. The power generation system as defined in claim 4 or 5, further comprising electrical power switching equipment for connecting and disconnecting electrical power from said compressed gas motor-generator subsystem to said local power grid to increase a power supply to said local grid during peak demand.

8. The power generation system as defined in claim 7, wherein said electrical power switching equipment is further configured to switch over electrical power between said compressed gas motor-generator subsystem and said electrical generator connected to said prime mover without interruption.

9. The power generation system as defined in claim 4 or 5, wherein said compressed gas motor-generator comprises a gas motor connected to a shaft of said electrical generator connected to said prime mover.

10. The power generation system as defined in any one of claims 4 to 9, further comprising a controller configured to sense a load demand of said local power grid and in response thereto to cause said compressed gas motor-generator to generate electrical power for said local power grid.

11. The power generation system as defined in any one of claims 1 to 10, further comprising a fuel generator configured to receive carbon dioxide from said liquid carbon dioxide collector and to produce a fuel therefrom.

12. The power generation system as defined in claim 11, wherein said fuel generator comprises a plasma reactor for converting carbon dioxide into carbon monoxide.

13. The power generation system as defined in claim 11 or 12, further comprising an intermittent electrical power source connected to said fuel generator.

14. The power generation system as defined in any one of claims 1 to 13, further comprising a storage vessel connected to said liquid carbon dioxide collector for storing said liquid carbon dioxide.

15. The power generation system as defined in any one of claims 1 to 14, wherein said liquid carbon dioxide collector comprises a cooling system for cooling said pressurized gas to improve collection of said liquid carbon dioxide.

16. The power generation system as defined in claim 15, wherein said cooling system comprises a heat exchanger in communication with ambient air, said ambient air typically being below 0 degrees Celsius.

17. The power generation system as defined in claim 15, wherein said cooling system comprises a heat pump, preferably for cooling said pressurized gas to below −15 degrees Celsius, and more preferably to below −25 degrees Celsius.

18. The power generation system as defined in any one of claims 1 to 17, wherein said gas compressor is configured to compress gas to a pressure in the range of 18 bar to 50 bar, preferably between 24 bar and 35 bar.

19. The power generation system as defined in any one of claims 1 to 18, further comprising one or more compressed gas storage vessels for storing said pressurized gas.

20. The power generation system as defined in any one of claims 1 to 19, further comprising a soot separation centrifuge for removing particulates from said combustion gas exhaust.

21. The power generation system as defined in any one of claims 1 to 20, further comprising a water condenser for condensing water in said pressurized gas and for separating said condensed water from said pressurized gas.

22. The power generation system as defined in any one of claims 2, 3 and 5 to 10, wherein said heat exchanger sub-system further comprises a heat storage unit for storing heat.

23. The power generation system as defined in any one of claims 1 to 22, further comprising a compressed air storage unit connected to said liquid carbon dioxide collector receiving the remainder of the pressurized gas once said liquid carbon dioxide has been collected by said carbon dioxide collector.

24. The power generation system as defined in any one of claims 11 to 13, further comprising:
a sub-combustion prime mover for combusting the fuel produced from said liquefied carbon dioxide; and
a sub-electrical generator connected to said sub-prime mover.

25. A method of combusting fuel and storing carbon dioxide produced therefrom when the ambient temperature is at least below −15° C.:
combusting an original fuel to produce electrical power;
compressing said combustion gas exhaust to produce pressurized gas and gas compression heat;
extracting said gas compression heat from said pressurized gas; and
further lowering the temperature of said pressurized gas by allowing said pressurized gas to reach said ambient temperature, wherein said further lowering of said temperature causes at least a portion of said carbon dioxide that is part of said pressurized gas to liquefy and separate from said pressurized gas.

26. The method as defined in claim 25, further comprising producing fuel from said liquid carbon dioxide.

27. The method as defined in claim 26, wherein said producing of said fuel uses an intermittent renewable energy source.

28. The method as defined in claim 26 or claim 27, wherein said fuel that is produced is carbon monoxide, and said producing of carbon monoxide comprises:
evaporating said liquefied carbon dioxide; and
transporting said gaseous carbon dioxide into a central channel of an inductive coupled plasma torch.

29. The method as defined in claim 26 or claim 27, wherein said fuel that is produced is ethanol.

30. The method as defined in any one of claims 25 to 29, further comprising centrifuging said combustion gas exhaust to remove from said combustion gas exhaust the particulates that are present within said combustion gas exhaust.

31. The method as defined in any one of claims 25 to 30, further comprising, prior to said step of further lowering the temperature, removing water that is part of said pressurized gas that has condensed.

32. The method as defined in any one of claims 25 to 31, wherein said producing of said fuel is performed using at least one of solar power and wind power as said intermittent renewable power source.

33. The method as defined in any one of claims 25 to 32, further comprising utilizing a heat pump to further cool the pressurized gas to below −15 degrees Celsius, and preferably to below −25 degrees Celsius.

34. The method as defined in any one of claims 25 to 33, wherein said compressing results in a pressurized gas with a pressure in the range of 18 bar to 50 bar, preferably between 24 bar and 35 bar.

35. The method as defined in any one of claims 26 to 29, further comprising combusting said produced fuel to produce electrical power.

36. The method as defined in claim 35, wherein said combusting of original fuel and said combusting of said produced fuel is to produce a set amount of electrical power, and wherein said electrical power produced from said combusting of produced fuel results in the lowering of the combustion rate of said original fuel.

37. The method as defined in any one of claims 25 to 36, further comprising producing electrical energy from said pressurized gas, once said liquefied carbon dioxide has been separated from said pressurized gas, by expanding said pressurised gas and by using a compressed-gas motor generator.

38. The method as defined in claim 37, further comprising heating said pressurized gas prior to or during said expanding of pressurized gas.
